(19) United States
(12) Patent Application Publication
(10) Pub. No.: US 2006/0072721 A1
(43) Pub. Date: Apr. 6, 2006

(54) Mobile messaging system and method

(75) Inventor: Maciej Wisniewski, New York, NY (US)

Correspondence Address: MINTZ LEVIN COHN FERRIS GLOVSKY & POPEO, 666 THIRD AVENUE, NEW YORK, NY, 10017, US

(73) Assignee: Netomat, Inc., New York, NY (US)

(21) Appl. No.: 11/233,168

(22) Filed: Sep. 21, 2005

Related U.S. Application Data
(60) Provisional application No. 60/611,746, filed on Sep. 21, 2004.
(60) Provisional application No. 60/685,304, filed on May 26, 2005.

(51) Int. Cl. H04M 1/64

(52) U.S. Cl. 379/88.22

(57) ABSTRACT

Systems and methods are provided for messaging with mobile devices (e.g., cellular phones and personal digital assistants (PDAs)) and, more particularly, to systems and methods for messaging multiple media with mobile devices.

### CROSS-REFERENCE TO RELATED APPLICATIONS

This claims the benefit of U.S. Provisional Patent Application Ser. Nos. 60/611,746, filed Sep. 21, 2004, and 60/685,304, filed May 26, 2005, which are hereby incorporated by reference herein in their entireties.

### FIELD OF THE INVENTION

Embodiments of the invention relate to systems and methods for messaging with mobile devices (e.g., cellular phones and personal digital assistants (PDAs)) and, more particularly, to systems and methods for messaging multimedia with mobile devices.

### BACKGROUND OF THE INVENTION

Traditionally, messaging multimedia (e.g., text, images, video and audio) with mobile devices is cumbersome and in many cases impossible. For example, Short Message Service (SMS) is limited to the transmission of text messages of 160 characters or less. While Multimedia Messaging Service (MMS) allows for the transmission of text as well as other media, MMS lacks persistence, which is the storage of messages remotely from the sender(s) and recipient(s) after the messages have been delivered to the recipients. Particularly, after a message is delivered via MMS, the server responsible for the delivery does not retain a copy of the message for, for example, later reference or re-use of the multimedia content. Consequently, the ability for mobile users to collaborate with one another on an ongoing basis through the use of MMS is limited significantly. Moreover, conventional approaches for delivering multimedia to mobile devices via the Internet Protocol (IP) channel (e.g., via IP Multimedia Subsystem (IMS) or through a browser running on a mobile device) can be greatly improved in terms of both delivery time and networking reliability.

Accordingly, it would be desirable to provide mobile messaging systems and methods that address these and other shortcomings of conventional systems for messaging media with mobile devices.

### SUMMARY OF THE INVENTION

Embodiments of the invention relate to improved systems and methods for messaging multiple media with mobile devices. The messaging experience provided to a mobile user is improved by facilitating multimedia collaboration, increasing efficiency of content delivery and/or networking reliability, and/or enhancing end-user functionality. For example, the messaging experience of a mobile user can be made to rival or surpass the messaging experience provided to desktop and other non-mobile devices, which traditionally has surpassed the messaging experience of mobile devices in terms of both ease of use and functionality.

In one aspect, systems and methods are provided that allow mobile users to collaborate with users of other devices on an ongoing basis through multimedia messaging (e.g., messaging with text, images, video and/or audio). For example, in one embodiment, multimedia messages generated by mobile and non-mobile devices are automatically tagged with identifying meta-information (e.g., author, date, time and/or location) prior to persisting (i.e., storing) the messages and associated meta-information as “documents” (or portions thereof) remotely from the message sender(s) and recipient(s). The documents are maintained in the remote storage even after the message(s) are communicated to the recipient(s), which allows the message(s) to be, for example, searched and/or sorted based on the meta-information and accessed for future reference, revision and/or re-use of the multimedia content. Additionally, the sender(s) and recipient(s) may be designated as document participants, thereby establishing an association that creates a messaging community between the participants. Members of the same community (i.e., participants in the same document) may be provided with various functionality specific to that community such as, for example, the ability to initiate real-time communication with other members of the community (e.g., a user selecting another user's online ID from a list of participants in a document in which both users participate), send a message to all other members of the community, and determine which community members are currently accessing the document that forms the basis for the community. Thus, a user who participates in multiple documents may be a member of multiple messaging communities.

As used herein, a document includes any one or more types of multimedia (and optionally associated meta-information) that is communicated between sender(s) and recipient(s) and that is stored remotely from the senders and recipients after the communication. Documents may be stored remotely in a single location, in a distributed arrangement, or in any other suitable approach. In a preferred embodiment, each document includes one or more related messages called “fragments” (e.g., a first fragment including a multimedia message from a sender to one or more recipients and meta-information that identifies the sender, and additional fragment(s) including multimedia response(s) from the recipient(s) and information that identifies the recipient(s)). The order in which fragments of the same document have been persisted to the remote site may be captured in the meta-information for the fragments. This meta-information (e.g., timestamp) may be used to, for example, replay the multimedia dialogue between the document participants in the order in which the dialogue occurred or in a user-defined order. Optionally, a history file selectable by a user having access rights to the document may also be provided. The history file may include a table of contents that identifies fragments of the document (e.g., by their associated meta-information) in, for example, the order in which the fragments have been persisted to the remote site. The user may select an entry from the table of contents in order to navigate to the corresponding fragment in the document.

In another embodiment, a single append function is provided that allows users of different devices to simultaneously write to (e.g., add to or modify) a stored document (e.g., persist a fragment to a document stored remotely from the devices). This contrasts with traditional approaches that use locking mechanisms for granting permissions to stored content in which only a single user can access/modify the stored content at a given time and in which subsequent users that request write access to the content are added to a queue.

In other embodiments, social networking protocols are provided that allow parties associated with participants in a document (e.g., a “friend” or a “friend-of-a-friend” of a document participant) to access the document and its associated multimedia content (and optionally meta-information). Such a party may also become a document participant when, for example, the party messages a response that is appended to the document.

In another aspect, systems and methods are provided that facilitate the delivery of multimedia messages to mobile devices. For example, in one embodiment, XML-based multimedia messages are encoded with XML “short codes” that reduce the size of the messages, thereby reducing both the amount of XML encoding by the sending equipment, and the amount of XML decoding by the receiving equipment, that is required for communicating the messages to recipients. Particularly, when the structure of an XML tree or sub-tree in a message adheres to a default structure (e.g., such as when a client application responsible for playing messages and running on the recipient's device includes a toolbar or other graphical user interface (GUI) aspect that remains static from message to message), the coded portion of a message that defines the structure of the tree or sub-tree can be replaced with abbreviated code representing the structure. The particular trees or sub-trees for which short codes are defined may be determined either in advance of, or during, the message flow. For example, a client application installed on a client device may already include or may acquire short code definitions at the time of the installation. Alternatively or additionally, short codes may be defined on-the-fly for trees or sub-trees that appear in the messaging flow (e.g., defining a short code for a sub-tree in response to determining that the sub-tree has appeared in the message flow more than a threshold number of times such as once). Upon defining a short code, that short code definition may be provided to the messaging equipment of document participants and/or to servers responsible for the remote storage of the messages. In a preferred embodiment, the XML short codes are netomatic markup language (nml) short codes, where nml is the XML-conformant language described in U.S. Publication No. 20020178164, published Nov. 28, 2002, and entitled “Sharing, Managing and Communicating Information Over a Computer Network,” which is hereby incorporated by reference herein in its entirety.

In another embodiment, only a portion of a document is communicated to a mobile device at a given time. For example, based on the bandwidth and/or latency of the communication network, and/or the processing and/or storage capability of the mobile device, one or more fragments of the document may be communicated to the mobile device. Another one or more fragments of the document may be communicated to the mobile device in subsequent transmissions. The fragments may be “self aware” in that they include all of the information needed by the mobile device to reassemble the document.

In still another embodiment, non-text multimedia of a message is communicated to a mobile device as inline ASCII encoded binary assets at the same time a text portion of the message is communicated to the device. The ASCII encoded assets may be compressed to reduce message size. In contrast, conventional approaches for delivering multimedia messages to mobile devices involve delivering the text portion of the message to the device, where the text portion includes a series of references to the non-text media. Then, each piece of non-text media is delivered to the mobile device in response to a separate request for the media from the device. Multiple requests for information may result in errors due to one or more of the requests not being received by a server or due to transmission errors in the content received by the mobile device. Multiple requests for information also increase network delays (i.e., latency).

In another embodiment, mobile devices may communicate with a multimedia server through a “lazy” push and/or pull notification protocol, in which a mobile device and the multimedia server only communicate when the device or server experiences a change in status. For example, when the launch status of the mobile device changes (e.g., the device goes “online” or “offline”), the device may send (push) to the server a one-byte notification that indicates this launch status (and other “presence” information such as “busy,” “away,” “typing,” “idle,” etc.). The notification may also serve as a request (pull) for messages and/or other updates from the server, such as a request for the presence of other mobile users (e.g., users listed in the mobile user's friends list). In another example, the server may send (push) alerts regarding updates to the mobile device when such updates become available. This lazy push and/or pull protocol minimizes the amount of network traffic needed for messaging with mobile devices and therefore reduces, for example, network latency.

In yet another embodiment, a mobile device may make multiple requests for information in a single call to a server. For example, a single call may include a first request for presence information from a presence interface and a second request for syndicated content from a subscription interface. In contrast, conventional methods issue separate calls, one per each request. Like the lazy push and/or pull protocol, this also minimizes the amount of network traffic needed for messaging with mobile devices.

In another embodiment, syndicated content (e.g., a news feed) is communicated from a syndicated content server to mobile devices by way of an intermediary server. When a mobile device requests the syndicated content, the intermediary server sends to the device a reference (link) to the location in memory (of the intermediary server or other memory such as a server hosted by a third-party content provider) where the syndicated content is stored. For example, the device can then access the content by following the reference, without having to download and store the content itself. In this way, duplicative storage of content and retrieval of the content from the syndicated content server is avoided and network traffic is reduced. This is in contrast to the conventional approach of requiring each user's device to access and download the content directly from the content server.

In another aspect, various functionality is provided that enhances the functionality provided to users of mobile devices. This functionality may be provided at least in part by a client application that may be downloaded from the internet and installed on a mobile device from or resident in memory on the mobile device at the time the device is purchased by the end user. In another example, the messaging functionality may be provided in a clientless approach by resources of a mobile device (e.g., a browser and/or media player) other than a dedicated client application.

In one embodiment, document-level presence information may be provided (as an alternative to or in addition to user-presence information) that indicates, for example, whether a document is available for review, whether the document has changed, who is accessing or working on the document and/or when the document was last updated. For example, when a mobile user activates the client application, the user may be presented with a display summarizing one or more documents in which the user is a participant or has been invited to participate, along with one or more of the document-centric features just described.

In another embodiment, functionality may be provided that allows the user to record, playback and edit messages and message threads. For example, based on meta-information for multimedia content stored at a remote site, the user may be presented with an option to search the message content. In addition, the meta-information enables playback of messages, for example, selective playback in which the user can filter the messages based on time, date and/or location.

In another embodiment, “push to message” functionality may be provided for sending a message to a user that is currently offline, for scheduling delivery of a message for a specified date and time and/or geographic location, and/or for connecting with a user (and zero or more other users) when that user retrieves a message.

While the aforementioned features of embodiments of the present invention are described primarily in the context of mobile devices, these features may also be applied to messaging with non-mobile devices (e.g., desktop computers).

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a diagram of a multimedia messaging system in accordance with an embodiment of the present invention;

FIG. 2A is a screen shot of an illustrative display provided by a multimedia client application running on a non-mobile device in accordance with an embodiment of the present invention, in which a document persisted to memory by server is displayed.

FIG. 2B is a screen shot of the same document shown in FIG. 2A, as displayed by a multimedia content application running on a mobile device in accordance with an embodiment of the present invention;

FIG. 3 is a flowchart of illustrative stages involved in messaging media in accordance with the present invention;

FIG. 4 shows the insertion of meta-information at document creation time in accordance with an embodiment of the present invention;

FIG. 5 is a screen shot of a mobile device display screen, in which seven images are transmitted to the mobile device in response to a single call to a multimedia server;

FIG. 6 shows a comparison of the delivery time of multimedia content as inline compressed ASCII encoded binary assets to a mobile device having a multimedia client application installed thereon versus the delivery time required for communicating the same message to an HTML browser;

FIG. 7 show a flow diagram of one-byte notification in accordance with an embodiment of the present invention;

FIG. 8 shows dynamic concatenation of client-server interfaces in accordance with an embodiment of the present invention; and

FIGS. 9 and 10 show delivery of content syndication via an intermediary server in accordance with an embodiment of the present invention.

### DETAILED DESCRIPTION OF THE INVENTION

Embodiments of the invention relate to a device- and network-agnostic multimedia messaging environment that provides a seamless experience for an end user, irrespective of whether the user is messaging from a mobile, desktop, set-top or other device. Within this environment, devices can message one another across different networks and/or protocols such as, for example, the Web (HTTP), SMTP/POP/IMAP, SIP, CDMA and GSM (GPRS, EDGE).

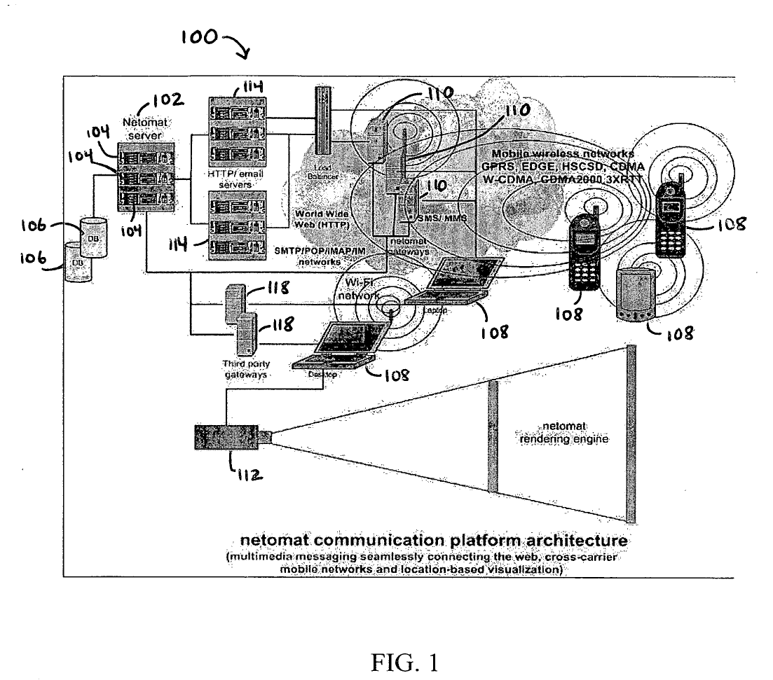

FIG. 1 shows an embodiment of a system 100 that includes server(s) 102 (each comprising one or more server interfaces 104 and memory 106) and user equipment 108 such as, for example, one or more mobile devices such as cellular phones and personal digital assistants (PDAs) and/or non-mobile devices such as desktop computers. System 100 also includes gateways 110, rendering engine(s) 112, HTTP/e-mail servers 114, load balancer(s) 116, and third-party gateways 118. For example, embodiments of the present invention may allow a user of a mobile or non-mobile device to view presence information for a mobile user in order to determine the launch status of a mobile user (e.g., online, offline, busy, away, typing, idle, etc.), and to engage the mobile user in a communication involving multiple media such as text, images, audio and video. Messages communicated between user equipment 108 (and optionally meta-information associated with the messages) are persisted (stored) by server 104 as documents (or portions thereof) in memory 106 for, for example, later reference and/or re-use of multimedia content in future messages. When the documents in system 100 are nml-based documents, system 100 at its various components may be labeled with the “netomat” modifier (e.g., netomat server 102).

Mobile and non-mobile devices may be networked to system 100 through the use of either a client or clientless approach. In the former case, a client application may be installed on a device, for example, subsequent to a user of the device downloading the client from the internet. For example, the client for a mobile device may be a small footprint application written in Java (i.e., when the mobile device is a java-enabled device). In one embodiment, such an application may be created using the J2ME MIDP 2.0 platform, which may also include the MIDP 1.0 platform with MMAPI (Multimedia API) and WMA (Wireless Messaging API) support. For example, the client may range in size from 50 k to 150 k depending on the particular mobile device on which the client is installed. In another embodiment, the mobile client may be an XHTML user content management interface. Examples of client applications for non-mobile devices include a Java 1.4 application, Java 1.1 applet, Macromedia Flash 6.0 applet, or XHTML user content management interface. Clientless devices may be networked to system 100 through the use of resources (e.g., a browser, text messaging and/or media player) that reside on the device other than a dedicated client application. Generally, devices having a client application installed thereon for multimedia messaging may have increased messaging capability relative to clientless devices. For example, a clientless device may support all of the functionality described herein, with the possible exception of XML “short codes” and inline compressed ASCII encoded binary assets.

Server 102 is responsible for managing all incoming and outgoing requests (e.g., a request for updates or to communicate a message to or from a mobile user 108), interfacing with memory 106, and providing server interfaces 104. In one embodiment, server 102 is a J2EE application server.

Server interfaces 104 may provide varying information to mobile and non-mobile devices 108 and may allow devices 108 to connect to server 102 in a unified way. For example, interfaces 104 may include one or more of the following interfaces: upload assets interface (UAI), manage assets interface (MAI), versioning interface (VI), notification interface (NI), presence interface (PI), subscription interface (SUI), permission and ticketing interface (PTI), invite interface (II), user data management interface (UDMI), access management interface (AMI), search interface (SI) and web services interface (WSI).

UAI may be responsible for uploading of all text and binary assets to the server. MAI interface responsible for remote management of user's assets such as, for example, accessing a fragment persisted at the remote site and referencing the fragment in a new document, thereby re-using the multimedia content. VI may be responsible for versioning of all updates and generating history files for fragments of a document. NI may be responsible for notifying users of updates to their spaces (which include documents (e.g., message threads) originated by the user as well documents in which the user is only a participant). PI may be responsible for presence information such as, for example, information indicating the launch state of each of the parties listed in a user's friends list as well as additional presence information. SUI may be responsible for syndication of content. PTI may be responsible for setting and getting permissions for read and write access to user's content. II may be responsible for one-time invitation to a user's space, and which may set different permission settings than PTI. UDMI may be responsible for managing user data such as profiles and address books. AMI may be responsible for password protection and password management of user's content. SI may be responsible for querying user data and user content (e.g., searching information and content publicly available to all users of system 100 or searching private information such as information available only to document participants). WSI may be responsible for integrating web services into a client application running on user equipment 108. For example, WSI may use the Simple Object Access Protocol (SOAP) protocol for communication and may have built-in support for Web Service Description Language (WSDL).

Gateways 110 are server-side applications that create a bridge between the multimedia messaging system of embodiments of the present invention and other communication systems. For example, gateways 110 may include one or more of the following gateways: SMS/MMS gateway (SMSG), electronic mail (e-mail) gateway (eMailG), presence gateway (PresenceG), instant messaging gateway (IMG), content streaming gateway (CSG) and search gateway (SG). SMSG allows for SMS and MMS messages from devices 108 to be persisted as fragments to memory 106 by server 102. eMailG allows for integration of text-based e-mail messages and e-mail messages with attachments into documents persisted to memory 106. PresenceG allows for integration with other presence-based systems (and therefore use of the presence information from these systems) such as Jabber or Wireless Village, prim and/or simple. IMG allows for integration with instant-message-based systems such as Jabber, AIM, Wireless Village and ICQ. CSG allows for integration with streaming technologies (e.g., for streaming audio and video). SG allows for integration with existing search technologies such as Google and MSN search. For example, search terms entered into a graphical user interface (GUI) displayed on user equipment 108 (e.g., the GUI associated with by a client application running on equipment 108) may be translated by the SG into a format recognizable by a search technology, and then provided to the search technology. Search results returned by the search technology may be translated into an appropriate format (e.g., the XML-conformant language nml) and tagged with meta-information (e.g., source information indicating the search technology used for the search and/or any meta information provided with the search results by the search technology) prior to causing user equipment 108 to display the results.

Server 102 typically sends SMS (text) or internet protocol (IP) packet notifications to user equipment 108 in order to alert the equipment that, for example, netomat messages or updates are available (e.g., updates to presence information and/or updates to syndicated content). With respect to SMS messages, the particular form and content of the message may vary depending on whether the device to which the notification is addressed is a client or clientless device. To that end, netomat server 102 may store in memory 106 or otherwise have access to a list of devices (e.g., mobile devices) having clients installed thereon.

For example, in response to server 102 determining that a mobile device 108 is a clientless device, server 102 may send to the notification to the device via SMS, where the SMS notification indicates that new message(s) and/or update information are available from server 102. The SMS notification may include, for example, an external link to a document (or portion thereof) or to other content such as syndicated content persisted by server 102 in memory 106. Automatically upon receiving the notification in the form of a wireless application protocol (WAP) push message (for example) or in response to the user selecting the link, the browser of a clientless mobile device may access and play the document or syndicated content for the user (e.g., display video, text or images in the display area of the mobile device, transmit audio via a speaker of the mobile device, or a combination thereof). One or more fields in which the user can enter and submit text for messaging a response may also be displayed. In another example, system 100 may allow users of the clientless mobile devices to respond to the notification with an SMS message, which may be persisted by server 102 as a text fragment in memory 106.

Alternatively, in response to server 102 determining that a mobile device 108 has a client application for multimedia messaging installed thereon, server 102 may send to the device an SMS notification that includes a port number for the client application in the notification header. This may trigger automatic launching of the client application upon receipt of the message by the mobile device. Once launched, the client application may access a document persisted to memory 106 by server 102 (a link to which may be provided in the SMS notification) and allow the user to issue a multimedia message response. Moreover, when the client application is in the launched state, notifications of messages or updates may be sent by server 102 through the IP channel instead of via SMS. To that end, server 102 may store or otherwise have access to data indicating which of the mobile devices having clients installed thereon are in the launched state. Additional details regarding determining by server 102 whether a client application running on a mobile device 108 is in the launched state are provided below in connection with the description of one-byte ‘lazy’ push or pull notification.

Rendering engine 112 in system 100 may be a software module that displays and/or manipulates multimedia content messaged in the system by user equipment 108 and/or other content (e.g., syndicated content). For example, rendering engine 112 may generate a public display in a physical space, such as an electronic billboard or a projection in a concert arena. Alternatively or additionally, rendering engine 112 may publish the content on an internet page (e.g., a world wide web page). The publishing and processing of content can happen in real-time, such as for voting or polling from mobile and desktop devices. The rendering engine may also generate an animated movie-like experience from the static input of a user, in the sense that the rendering engine may play back the fragments of a document automatically in the order in which the fragments were persisted to the remote site.

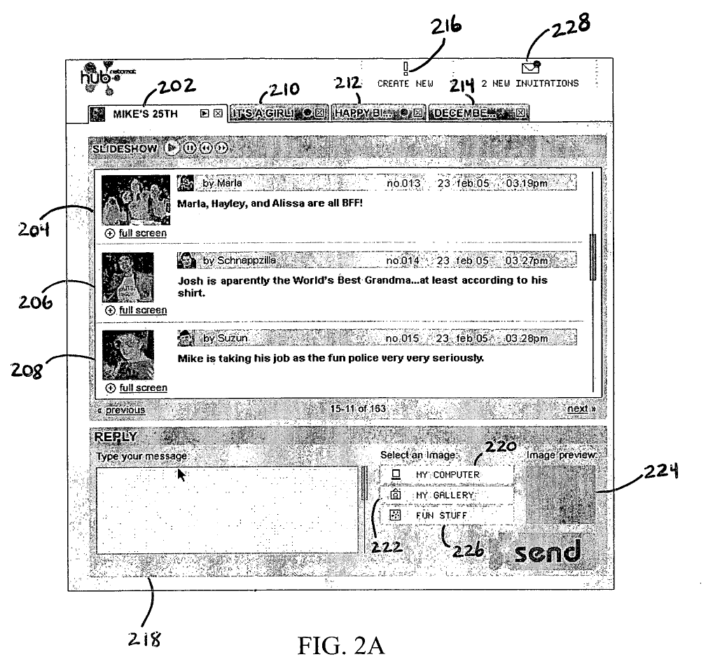

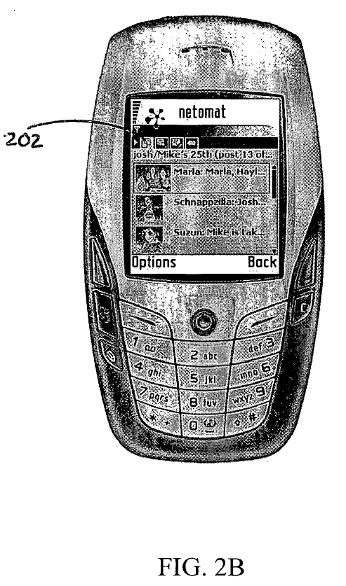

FIG. 2A is a screen shot of an illustrative display provided by a multimedia client application displayed on, for example, a desktop device in accordance with the present invention. In FIG. 2A, a document persisted to memory 106 by server 102 is displayed for the user. More specifically, FIG. 2A provides an overview of the user's space, which may be conceptualized as the set of documents in which the user is a document participant (i.e., the set of documents for which the user has authoring rights). As shown, the document entitled “MIKE'S 25TH” 202 is currently selected within the display. Thus, fragments 204, 206 and 208 of document 202 are displayed for the user, and each fragment includes multiple media including text and images and corresponding meta information (e.g., author, date and time). The display may also include a variety of selectable options. Options 210, 212 and 214 are also provided in order to allow the user to select documents “IT'S A GIRL,” “HAPPY BI...” and “DECEMBE...” for display, respectively. Option 216 may be provided in order to allow the user to create a new document. Reply field 218 may allow the user to submit a multimedia response for communication to the participants in the current document 202. As shown, multimedia (e.g., an image) may be selected for inclusion in the response from local storage of the device (“My Computer” option 220) or from an allocation in remote storage such as in memory 106 dedicated to storage of user-specified content (“My Gallery” option 222). “Fun Stuff” option 226 may allow the user to access third-party multimedia content (e.g., syndicated content) from remote storage. Preview window 224 may allow the user to preview the image before sending the multimedia message. Option 228 may indicate that two new invitations to participate in documents are available to the user. Selection of option 218 may allow the user to review the invitations and/or profile information regarding the sender of the invitations. Choosing to accept an invitation may cause the corresponding document and its associated information to appear in the display.

FIG. 2B is a screen shot of the same document 202 shown in FIG. 2A, as displayed by a multimedia content application running on a mobile device in accordance with an embodiment of the present invention. The options available to the mobile user may be similar to or the same as those presented to the user in the example of FIG. 2A. However, due to the smaller display of the mobile device, the user may be required to, for example, scroll the display in order to access the options.

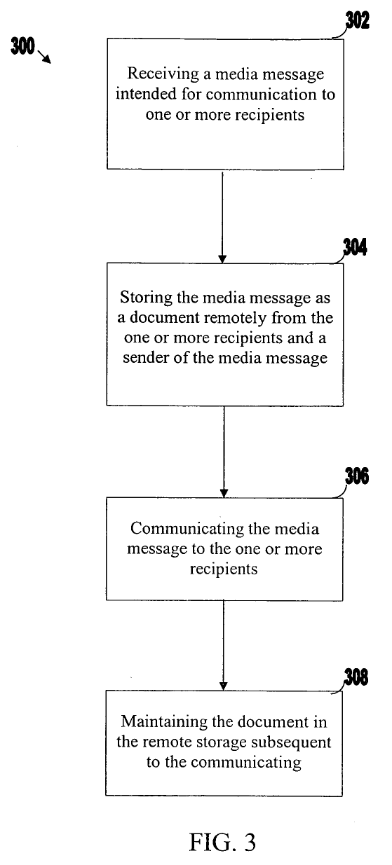

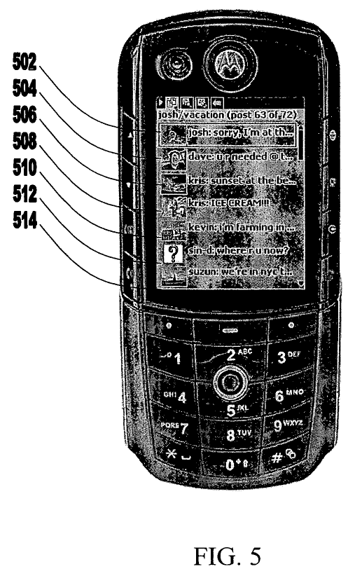

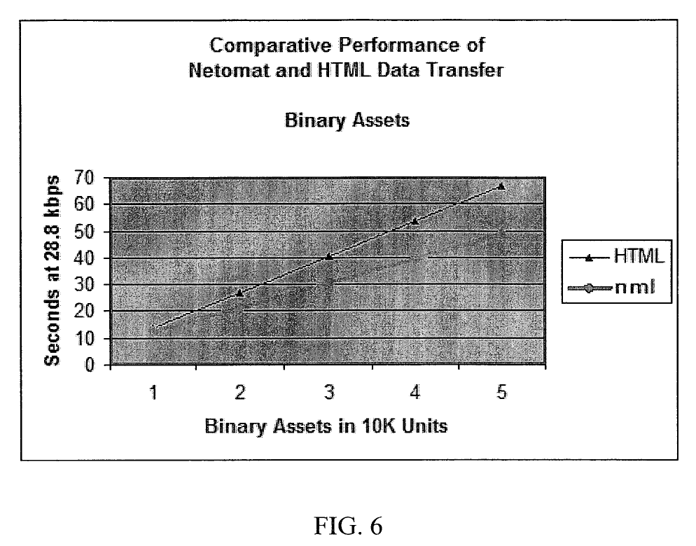

FIG. 3 is a flowchart 300 of illustrative stages involved in messaging media in accordance with the present invention. At stage 302, server 102 may receive from user equipment 108 (e.g., mobile user equipment) a media message intended for communication to one or more recipients (e.g., another installation of mobile user equipment). At stage 304, server 102 may storing the media message as a document in memory 106 (e.g., remotely from the one or more recipients and the sender of the media message). At stage 306, server 102 may communicate the message to the one or more message recipients. For example, server 102 may notify a recipient of the message by transmitting a document invitation or other notification to the recipient, and may communicate the message to the recipient in response to the recipient accepting the invitation. Communicating a message to a recipient includes sending a link to a message stored remotely and/or transmitting (e.g., streaming) all or a portion of the message to a recipient device. In a preferred embodiment, multimedia content from the message is preferably communicated to the recipient as compressed ASCII binary encoded assets, which is described below in connection with FIGS. 5 and 6. At stage 308, server 306 may maintain the document in remote storage subsequent to communicating the document to the one or more recipients, which may allow the document (and its multimedia content) to be referenced and/or re-used in future messages. In an embodiment, server 102 may designate as participants in the document users who have accepted invitations to join the document or who have messages appended to the document as fragments, thereby creating an association between the users. This association may establish a community of users, who may be provided with functionality specific to that community.

In an aspect of the present invention, systems and methods are provided that allow mobile users 108 to collaborate with users of other devices on an ongoing basis through multimedia messaging (e.g., messaging with text, images, video and/or audio). For example, multimedia messages generated by mobile and non-mobile devices 108 may be tagged automatically with identifying meta-information (e.g., author, date, time and/or location) prior to server 102 persisting the messages and associated meta-information as documents (e.g., or fragments of documents) in memory 106 remotely from the message sender(s) and recipient(s). As another example, a single append function may be provided that allows users of different devices 108 to write (e.g., add or modify) simultaneously to a stored document (e.g., persist a fragment to a document stored remotely from the devices). Still another example, social networking protocols may be provided (e.g., a “friend-of-a-friend” protocol) that allow stored documents and their associated multimedia content (and optionally meta-information) to be accessed by parties other than the original message recipient(s). These features are now described in greater detail.

Automated Meta-Information Tagging of Messaged Content

Web resources contain meta tags that provide information about authorship, links, keywords, and descriptions. This information is useful for search and machine processing of documents. One current method for this is RDF, an extension of XML, which provides a framework with tools for authoring, manipulating, and searching machine-generated meta data that can then be efficiently processed by other machines.

Currently, supplying meta data through methods such as RDF tags requires some human input (for example, explicitly supporting information or entering the tags). However, automatically inserting tags is necessary to describe the quantity of documents that are created in communications systems, especially in embodiments of the present invention in which the multimedia messaging system allows concurrent updates via a fragment append operation (described in greater detail below).

In an embodiment, the present invention uses automated meta-information tagging to describe each document or portion thereof. For example, in a preferred embodiment in which every document includes one or more fragments, each fragment within a document may be tagged with meta information indicating the creation location, date, and author of the fragment. With respect to mobile devices, the location information may be generated based on, for example, the global position of the mobile device as measured by a global positioning system (GPS), an identification for the mobile device (e.g., cellular ID), and/or based on input from the user (e.g., an indication from the user that the user is within the state of New York. Location information for non-mobile devices may be based on GPS or in response to user input (e.g., the user profile of the user in which the user stated a zip code in which the user's device resides). Based on the meta information, fragments and documents can be searched, edited, and organized, with these changes viewable by others.

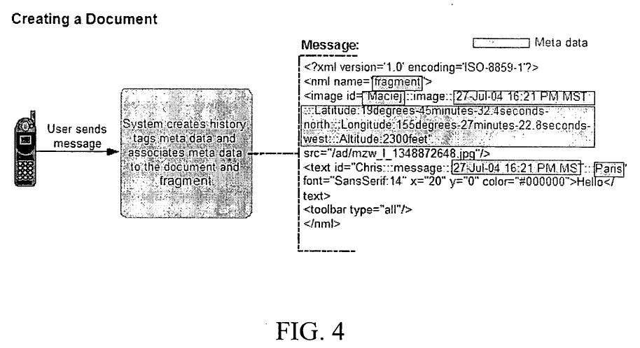

Automated meta-information tagging helps ensure that updated information is properly tagged for further use. In one embodiment, a client application running on user equipment 108 may tags a new message with the author, date, time, and location (all of which are a function of the sending device) before the message is sent to server 102. In another embodiment (e.g., when a message is sent from a clientless device), server 102 may tag messages with meta-information prior to persisting the messages in memory 106 or transmitting the content to another server in a distributed arrangement. FIG. 4 shows the insertion of meta-information at document creation time in accordance with an embodiment of the present invention. Particularly, a fragment of a document is tagged with a fragment name=“fragment,” an author name=“Maciej,” a date and time “27-Jul-04 16:21 PM MST,” and location information=“Paris” and “:::Latitude:19degress-45minutes-32.4seconds-north:::Longitude:155degrees-27mintues-22.8seconds-west:::Altitude:2300feet.” The fragment is then appended to a document, which may include one or more prior, related messages in the form of other fragments.

Global User-Managed File System with Single Append Operation

System 100 may provide a content management system that is globally accessible from any device 108, and may provides the ability to search, sort, send, delete, share, and reuse multimedia assets. In contrast, conventional file systems “lock” access to files that are being read or updated, with additional requests for those files added to a queue. Locking access requires additional processing time and server memory and can cause updates to be lost, changes to data that were not actually saved to be uploaded, and problems re-reading updated files.

The global file system provided by system 100 provides a simple and efficient way to update files, avoiding the problems described above. In a preferred embodiment, since all documents can be changed by appending new fragments rather than overwriting existing fragments, random writes within a document are virtually non-existent. Thus, once written, the fragments within a document are read-only and, for the most part, read sequentially. The global file system may be a domain-based system that organizes files hierarchically in directories and identifies them by path names in the domain, such as the path:
/m/a/c/iej/travel/index.v45.nml
   which may be located in the domain:
http://www.netomat.net

The global file system supports the standard open, close, create, delete, read and write operations, as well as a fragment append which allows multiple devices 108 to append a fragment to a document simultaneously while guaranteeing the integrity of each device's append.

This fragment approach is significantly simpler than traditional distributed file systems and therefore is easier to scale and more tolerant to errors. The fragment approach also helps eliminate the need for data synchronization between different end-user devices. Each of these problems are issues with current web-based protocols such as WebDAV which allows users to collaboratively edit, publish, and manage Web-resources through the use of a locking mechanism, but has also been prone to scalability problems and does not provide fragment append functionality.

Social Networking Protocols Built into the Messaging Flow and Protocol Layer

Current social networking applications provide many ways to recognize exchanges or relationships between users, along with providing features that encourage users to form social networks. In an embodiment, the present invention facilitates social networking through a more granular study of interaction patterns.

The present invention provides an automated way to define appropriate social rules, sometimes referred to as social contracts, for a given set of mobile devices based on actual interactions amongst the devices. For example, a user-created document can be linked using the “friend-of-a-friend” protocol, which only allows for people that know each other, or that have been introduced to each other, to send and receive messages, which may then be appended as fragments to the document.

For example, a friend's document may be created when a message is accepted by a receiving party (i.e., accessed by the receiving party as opposed to ignored or deleted), thereby creating a “link-of-trust” between the sending and the receiving party. Generally, this link of trust will be valid for the purposes of the instant document only, meaning that it will not give the receiving party access to other private documents in which the sender participates, and vice versa. In this way, a network of friends-of-friends can be grown organically from within an ongoing communication/collaboration between the users.

As another example, friends' lists, sometimes referred to as buddy lists, can be user created or automatically generated as a result of the Invite, Subscription and Notification processes of server interfaces 104.

Profiles may also be provided that are collections of user data created by users to represent and describe themselves, although users may be permitted to hide or restrict access to their profiles. Profiles are used for identifying users within a network. System 100 may support multimedia profiles as well as ‘reverse lookup’ of profiles during certain communications, meaning that (for example) a message recipient can review the profile a message sender prior to accepting a message from the sender. A profile is a user's public profile,.

Varying degrees of trust may be attributed to different social links. For example, the greatest degree of trust may be denoted between members of a friends' list. This varying trust and/or other user preferences may be used to filter the types of invitations to join social networks that system 100 allows to be delivered to the user. For example, system 100 may permit party invites to be delivered to the user unless the messages are determined to be objectionable based on, for example, attributes of the distribution list or subject tag (similar to SPAM-blocking for e-mail).

System 100 automates the process of creating social protocols. Because each message on the system is meta tagged, stored (unless the user deletes it), and searchable for later use, system 100 can track any social tie that occurs in the network. It is important to note that this ability may apply only to the links between message fragments and how messages are accessed, and not to the content of the messages.

In another aspect of the present invention, systems and methods are provided that facilitate the delivery of multimedia messages to mobile devices. For example, XML-based multimedia messages may be encoded with XML “short codes” that reduce both the amount of XML encoding by the sender(s), and the amount of XML decoding by the recipient(s), that is required for communicating the messages to the recipients. In another embodiment, only a portion of a document may be communicated to a mobile (or non-mobile) device at a give time depending on, for example, the bandwidth and/or latency of the communication network, and/or the processing and/or storage capability of the mobile device. In still another embodiment, non-text multimedia of a message may be communicated to a mobile device as inline ASCII encoded binary assets at the same time a text portion of the message is communicated to the device. In another embodiment, mobile users 108 may communicate with server 102 through a “lazy” push and/or pull notification protocol, in which a mobile device 108 and server 102 only communicate when the device or server experiences a change in status. In yet another embodiment, a mobile device 108 may make multiple calls for information to multiple server interfaces 104 in a single request. In another embodiment, server 102 may function as in intermediary between a syndicated content server (e.g., providing a news feed) and one or more mobile devices 108. This may avoid duplication of content storage and reduce network traffic. These features are now described in greater detail.

Abbreviated Encoding—XML Short Codes

An embodiment of the present invention provides a method for more efficiently transmitting XML-based documents, specifically over wireless networks. While reducing the size of a transmission is a goal for all communication methods, it is a dominant concern on resource-limited devices such as mobile phones, where efficiency is impacted by low bandwidth and high overhead. The invention reduces document size without requiring additional encoding software, thereby reducing the transmission size and eliminating the computational burden of encoding and decoding documents.

Existing messaging systems rely on two methods for encoding data for more efficient transmission over a network. These methods are binary encoding and compression. Both approaches have efficiency impacts in terms of the overhead required for interpreting the encoded transmission.

Binary encoding methods, such as WBXML (Wireless Binary XML), which encodes the file in a binary format. Drawbacks to binary encoding include the processing overhead on both user equipment and a multimedia server, associated with encoding and decoding and the additional memory for the encoding/decoding software.

Data compression is the other traditional approach for reducing the overhead and network bandwidth needed to store and transmit documents. As with binary encoding, data compression requires interpretation, thereby requiring compression/decompression software on each device, as well as introducing latency into the transmission/rendering process due to compression/decompression.

In an embodiment, the present invention provides a third solution that eliminates the need for XML encoding by identifying reusable markup language and substituting a short code for that language. In most cases this is more efficient than binary encoding and data compression. The invention reduces document size, saves network bandwidth, and does not require additional software, thereby saving memory on devices and eliminating overhead processing. In a preferred embodiment, in which system 100 transmits nml—(netomatic markup language) based documents, the short codes are (nml) short codes. nml is the XML-conformant language described in above-incorporated U.S. Publication No. 20020178164.

An nml short code represents one or many nml code elements. Short codes collapse the underlying structure of nml elements into a single code element. A short code can be substituted for any nml tree/sub-tree. Short codes are inserted when the application recognizes the default value of nml element(s), and when those values remain consistent during the lifecycle of the nml application. Short codes are processed by existing parsers and interpreters, which allows complex documents to be processed more efficiently without additional pre-preprocessing.

For example, the nml <toolbar> element contains elements and attributes that define the user interface of an nml application; attributes such as layout, look and feel, and functionality. An example of a <toolbar> definition with child elements and attributes is shown below:

```
<toolbar type=“all”>
  <formContainer name=“AddImage” id=“003”>
    <submit action=“http://mobile.netomat.net/account/addImage.jsp”
    target=“ImageForm” method=“GET” id=“01” name=“Add Image”>
    </submit>
  </formContainer>
</toolbar>
```

For example, the tree structure for the above coding may be represented as follows:

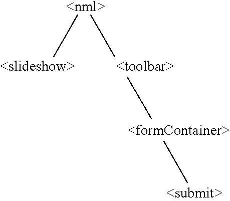

Thus, Rather than transmit the entire <toolbar> definition of this structure (as illustrated by the above tree) every time the user interface is required, a short code is sent.

The short code used in this situation may be as follows:
<toolbar type=“all”/>

The <toolbar> short code hides the attributes that define layout, look and feel and functionality. By providing an attribute value of “type=all” in the initial transmission of the toolbar element, the sub-tree belonging to that element is marked as eligible for a short code. The next time the application receives a <toolbar> element with a “type=all” attribute as in the above example, the application recognizes <toolbar> as a short code.

In another example, the short code ‘<slideshow>’ may be used in order to generate a sequence of images, as shown in the sample code below. It should be noted that it may be left up to the client application how to render the sequence of images to the screen. For example, the images may be preloaded and cycled by replacing one image with the next image, or they may be displayed in a scrollable area one below the other once the item is selected.

```
<slideshow x=“10” y=“10” width=“150” height=“136” period=“9000”>
  <image src=“/107-0784_IMG20634.JPG” y=“24” width=“150”
    height=“112”/>
  <image src=“/107-0785_IMG20633.JPG” y=“24” width=“150”
    height=“112”/>
  <image src=“/107-0786_IMG20632.JPG” y=“24” width=“150”
    height=“112”/>
  <image src=“/107-0787_IMG20631.JPG” y=“24” width=“150”
    height=“112”/>
  <image src=“/107-0788_IMG20630.JPG” y=“24” width=“150”
    height=“112”/>
  <image src=“/107-0789_IMG20629.JPG” y=“24” width=“150”
    height=“112”/>
</slideshow>
```

Thus, repeated code is marked by an identifying attribute and redundant code is not re-sent in subsequent communications. Using this approach, large chunks of a message exchange can be short-coded, effectively reducing the size of files that are transmitted across a network. In some cases, short codes can be denoted prior to the message exchange through predefined short codes. If a client application does not recognize the short code, the client application can send a message to server 102 and then the repeated code will be sent in its entirety.

Delivery of Multimedia Messages and Message Threads of Arbitrary Length

In another embodiment, the present invention eliminates problems associated with delivering large files and arbitrary-length messages over networks that have limited bandwidth and high latency to devices with limited storage. For example, XML and more specifically the XML-conformant language nml provides a simple solution for creating “chunkable” documents, as an alternative to more complex approaches such as XML Fragment specification for assembling XML fragments into a document.

With nml, there is no size limitation on documents. nml fragments provide the flexibility to deliver documents in chunks; i.e., data chunks belonging to a larger document, as opposed to a complete document.

A fragment is a part of a document and is small enough so that it can be delivered to, for example, mobile devices 108 which may have limited storage and processing capability. The number of fragments delivered at one time may be based on network throughput and device capabilities. System 100 may loads subsequent fragments over the network, giving the appearance that the document is being scrolled locally.

In an embodiment, the invention provides the ability to deliver 1 to n fragments as appropriate based on the network bandwidth and the device 108. There is no upper limit to the number of fragments that can be transmitted. The default number of transmitted fragments can be overridden dynamically as a user preference.

nml fragments can contain 0 or many nml objects (elements). nml objects are defined as objects in time and space, meaning that they contain attributes (meta-information, as previously described) defining the author, the last modified date/time stamp and its geographical location when available. An nml fragment is shown in FIG. 4.

This meta information causes the nml fragments to be “self-aware”, meaning that the information needed to reassemble a document is contained within the fragments themselves. Fragments do not require any rules or knowledge outside of the fragment. Any two nml fragments can be sorted based on this self-awareness.

Inline Compressed ASCII Encoded Binary Assets

As mobile networks expand, so does the need for faster, more efficient, and user-friendly ways of delivering formatted multimedia presentations to devices characterized by small screens and subject to unreliable network connectivity and low bandwidth. The existing method of exchanging multimedia in messages across mobile and fixed networks requires an exponentially higher number of client/server calls/responses when compared to the invention, thus placing higher demand on networks and exposing transmission sessions to network failures and users to longer wait times.

Conventional mobile applications, such as phone browsers, require the following steps to load a multimedia file such as HTML or XHTML that contains images. First, the HTML file must be loaded in response to a request from the user for the HTML file. Then, each embedded image in the HTML file must be loaded, where each embedded image requires a separate user request. Similar strategies are employed by MMS and other messaging systems. Multiple calls for information may result in errors due to one or more calls not being received by the server or due to transmission errors in the content received by the mobile device.

In an embodiment, unlike conventional systems, system 100 efficiently delivers multimedia content to mobile devices 108 by eliminating multiple calls and reducing message size. Particularly, a single call from a mobile device 108 causes server 102 to transmit an nml file containing ASCII encoded and compressed multimedia assets (e.g., compressed and encoded by server 102). When compressed, ASCII encoded and compressed files are 12 percent to 30 percent smaller. An additional 10 percent advantage is achieved by reducing the overhead required for every TCP/IP connection (i.e., by reducing the number of calls/responses). The ability to deliver a message containing multiple assets in one message results in faster delivery and delivers a significantly improved user experience. System 100 is uniquely suited for the mobile environment, where there is a need to reduce exposure to network unreliability and poor connections. System 100 also conserves the resources of server 102 by limiting the number of calls to which the server must respond. For example, FIG. 5 is a screen shot of a mobile device display screen, in which seven images 502-514 (and associated text) are transmitted to the mobile device in response to a single call to server 102 (FIG. 1).

FIG. 6 is a graph showing the delivery time required to deliver content including five images (size 50 k total) as inline compressed ASCII encoded binary assets to a mobile device having a multimedia client application installed thereon (and in which the message is an nml-message) versus the delivery time required to send the same content to an HTML browser of a mobile device (without the inline compression of ASCII encoded binary assets). More particularly, for delivery over a 28.8 kbps line, the compressed ASCII encoded binary assets were delivered in 48.4 seconds, whereas delivery of the same content to an HTML browser required 66.5 seconds.

The following shows illustrative code for an nml file that includes three images. In this example, the inline messages are compressed with standard data compression algorithms including a combination of the LZ77 algorithm and Huffman coding and encoded as Base64. An inline image (e.g., 1272 bytes) is smaller than the original image in the JPG format (e.g., 1564 bytes).

<?xml version=“1.0” encoding=“ISO-8859-1”?>
<nml>
<img enc=“base64”id=“mzw:::userpic” src=“user/profile/photo_smallthumb.jpg” x=“0”
Y=“0”>
/9j/4AAQSkZJRgABAQAAAQABAAD/2wBDAAYEBQYFBAYGBQYHBwYIChAK
CgkJChQODwwQFxQYGBcU
FhYaHSUfGhsjHBYWICwgIyYnKSopGR8tMC0oMCUoKSj/2wBDAQcHBwoIChMK
ChMoGhYaKCgoKCgo
KCgoKCgoKCgoKCgoKCgoKCgoKCgoKCgoKCgoKCgoKCgoKCgoKCgoKCgoKCj/
wAARCAAYACADASIA
AhEBAxEB/8QAHwAAAQUBAQEBAQEAAAAAAAAAAAECAwQFBgcICQoL/8Q
AtRAAAgEDAwIEAwUFBAQA
AAF9AQIDAAQRBRIhMUEGE1FhByJxFDKBkaEII0KxwRVS0fAkM2JyggkKFhcYG
RolJicoKSo0NTY3
ODk6Q0RFRkdISUpTVFVWV1hZWmNkZWZnaGlqc3R1dnd4eXqDhIWGh4iJipKT1J
WWl5iZmqKjpKWm
p6ipqrKztLW2t7i5usLDxMXGx8jJytLT1NXW19jZ2uHi4+Tl5ufo6erx8vP09fb3+Pn6/8
QAHwEA
AwEBAQEBAQEBAQAAAAAAAAECAwQFBgcICQoL/8QAtREAAgECBAQDBAc
FBAQAAQJ3AAECAxEEBSEx
BhJBUQdhcRMiMoEIFEKRobHBCSMzUvAVYnLRChYkNOE18RcYGRomJygpKjU2
Nzg5OkNERUZHSElK
U1RVVldYWVpjZGVmZ2hpanN0dXZ3eH16goOEhYaHiImKkpOUlZaXmJmaoqOkpaa
nqKmqsrO0tba3
uLm6wsPExcbHyMnK0tPU1dbX2Nna4uPk5ebn6Onq8vP09fb3+Pn6/9oADAMBAAIR
AxEAPwD58u7C
6upHeCOeQKOSnPPoB3rv/DfgfwxNaIPEuq3Ud4RnbbFFVPY5DZ+owKqJo8Nkkk9vf
7tq8q0eS3Pq
D7+1Yime7u50EG0DLIWcAMAPU4/zxXA5tqyO2NOK3Ra8XeHLLRp0ewuVu7Fv1SR
1AZTjgHsfr7Hg
VyOqKGhQLyM5xmuotop77RLoXCPBBDIsquehGCDjt3rDMbbf3UcsiEnay9CP85raK
sY1Ensei6B4
HZvD15qGoXrx3scXnR2cagNt/vMeencAccZIrlrxbgSjIIKthQ4B5z0wevTpRRS1BXLhN
pHU+HdI
fXdO1PS7qWazlEbFZnO5IypCmNlGcAlgN3Y9j0rk5tG1Pwprw07UJInUSeU/lybo+cfN
nHHBB/Oi
iuunBPQ6Mbh4wpKotz//2Q═
</img>
<img enc=“base64” id=“mzw:::userpic” src=“user2/profile/photo_smallthumb.jpg” x=“0”
y=“0”>
/9j/4AAQSkZJRgABAQAAAQABAAD/2wBDAAYEBQYFBAYGBQYHBwYIChAK
CgkJChQODwwQFxQYGBcU
FhYaHSUfGhsjHBYWICwgIyYnKSopGR8tMC0oMCUoKSj/2wBDAQcHBwoIChMK
ChMoGhYaKCgoKCgo
KCgoKCgoKCgoKCgoKCgoKCgoKCgoKCgoKCgoKCgoKCgoKCgoKCgoKCgoKCj/
wAARCAAYACADASIA
AhEBAxEB/8QAHwAAAQUBAQEBAQEAAAAAAAAAAAECAwQFBgcICQoL/8Q
AtRAAAgEDAwIEAwUFBAQA
AAF9AQIDAAQRBRIhMUEGE1FhByJxFDKBkaEII0KxwRVS0fAkM2JyggkKFhcYG
RolJicoKSo0NTY3
ODk6Q0RFRkdISUpTVFVWV1hZWmNkZWZnaGlqc3R1dnd4eXqDhIWGh4iJipKT1J
WWl5iZmqKjpKWm
p6ipqrKztLW2t7i5usLDxMXGx8jJytLT1NXW19jZ2uHi4+T15ufo6erx8vP09fb3+Pn6/8
QAHwEA
AwEBAQEBAQEBAQAAAAAAAAECAwQFBgcICQoL/8QAtREAAgECBAQDBAc
FBAQAAQJ3AAECAxEEBSEx
BhJBUQdhcRMiMoEIFEKRobHBCSMzUvAVYnLRChYkNOE18RcYGRomJygpKjU2
Nzg5OkNERUZHSE1K
U1RVVldYWVpjZGVmZ2hpanN0dXZ3eHl6goOEhYaHiImKkpOUlZaXmJmaoqOkpaa
nqKmqsrO0tba3
uLm6wsPExcbHyMnK0tPU1dbX2Nna4uPk5ebn6Onq8vP09fh3+Pn6/9oADAMBAAIR
AxEAPwD58u7C
6upHeCOeQKOSnPPoB3rv/DfgfwxNaIPEuq3Ud4RnbbFFVPY5DZ+owKqJo8Nkkk9vf
7tq8q0eS3Pq
D7+1Yime7u50EG0DLIWcAMAPU4/zxXA5tqyO2NOK3Ra8XeHLLRp0ewuVu7Fv1SR
1AZTjgHsfr7Hg
VyOqKGhQLyM5xmuotop77RLoXCPBBDIsquehGCDjt3rDMbbf3UcsiEnay9CP85raK
sY1Ensei6B4
HZvD15qGoXrx3scXnR2cagNt/vMeencAccZIrlrxbgSjIIKthQ4B5z0wevTpRRS1BXLhN
pHU+HdI
fXdO1PS7qWazlEbFZnO5IypCmNlGcAlgN3Y9j0rk5tG1Pwprw07UJInUSeU/lybo+cfN
nHHBB/Oi
iuunBPQ6Mbh4wpKotz//2Q═
</img>
<img enc=“base64” id=“mzw:::userpic” src=“user3/profile/photo_smallthumb.jpg” x=“0”
y=“0”>
/9j/4AAQSkZJRgABAQAAAQABAAD/2wBDAAYEBQYFBAYGBQYHBwYIChAK
CgkJChQODwwQFxQYGBcU
FhYaHSUfGhsjHBYWICwgIyYnKSopGR8tMC0oMCUoKSj/2wBDAQcHBwoIChMK
ChMoGhYaKCgoKCgo
KCgoKCgoKCgoKCgoKCgoKCgoKCgoKCgoKCgoKCgoKCgoKCgoKCgoKCgoKCj/
wAARCAAYACADASIA
AhEBAxEB/8QAHwAAAQUBAQEBAQEAAAAAAAAAAAECAwQFBgcICQoL/8Q
AtRAAAgEDAwIEAwUEBAQA
AAF9AQIDAAQRBRIhMUEGE1FhByJxFDKBkaEII0KxwRVS0fAkM2JyggkKFhcYG
RolJicoKSo0NTY3
ODk6Q0RFRkdISUpTVFVWV1hZWmNkZWZnaGlqc3R1dnd4eXqDhIWGh4iJipKTlJ
WWl5iZmqKjpKWm
p6ipqrKztLW2t7i5usLDxMXGx8jJytLT1NXW19jZ2uHi4+T15ufo6erx8vP09fb3+Pn6/8
QAHwEA
AwEBAQEBAQEBAQAAAAAAAAECAwQFBgcICQoL/8QAtREAAgECBAQDBAc
FBAQAAQJ3AAECAxEEBSEx
BhJBUQdhcRMiMoEIFEKRobHBCSMzUvAVYnLRChYkNOE18RcYGRomJygpKjU2
Nzg5OkNERUZHSE1K
U1RVVldYWVpjZGVmZ2hpanN0dXZ3eHl6goOEhYaHiImKkpOUlZaXmJmaoqOkpaa
nqKmqsrO0tba3
uLm6wsPExcbHyMnK0tPU1dbX2Nna4uPk5ebn6Onq8vP09fb3+Pn6/9oADAMBAAIR
AxEAPwD58u7C
6upHeCOeQKOSnPPoB3rv/DfgfwxNaIPEuq3Ud4RnbbFFVPY5DZ+owKqJo8Nkkk9vf
7tq8q0eS3Pq
D7+1Yime7u50EG0DLIWcAMAPU4/zxXA5tqyO2NOK3Ra8XeHLLRp0ewuVu7Fv1SR
1AZTjgHsfr7Hg
VyOqKGhQLyM5xmuotop77RLoXCPBBDIsquehGCDjt3rDMbbf3UcsiEnay9CP85raK
sY1Ensei6B4
HZvD15qGoXrx3scXnR2cagNt/vMeencAccZIrlrxbgSjIIKthQ4B5z0wevTpRRS1BXLhN
pHU+HdI
fXdO1PS7qWazlEbFZnO5IypCmNlGcAlgN3Y9j0rk5tG1Pwprw07UJInUSeU/lybo+cfN
nHHBB/Oi
iuunBPQ6Mbh4wpKotz//2Q═
</img>
<nml>

The following shows illustrative code for an HTML file that includes references to three images. Each image is size is 1564 bytes, and requires a separate call to the server. Thus, to display this document, four calls to the server are required (i.e., one to request the text and three additional requests, one for each image).

<html>
<head>
<title>Document containing three images</title>
</head>
<body>
<img src=“user/profile/photo_smallthumb.jpg” alt=“User picture”>
<img src=“user2/profile/photo_smallthumb.jpg” alt=“User picture”>
<img src=“user3/profile/photo_smallthumb.jpg” alt=“User picture”>
</body>
</html>

One-Byte “Lazy” Push or Pull Notification

Expanding usage of mobile devices continues to put increasing demand on messaging systems implemented across mobile and fixed networks. Current networks have significant limitations in terms of bandwidth and connectivity reliability, which often results in lost or corrupted messages. Current messaging systems face problems due to bandwidth and network reliability.

In an embodiment, the present invention provides a faster, more flexible messaging system for mobile and fixed networks by minimizing the amount of network traffic needed in the exchange of messages. The invention maximizes network and device resources, such as bandwidth and storage, while allowing users to choose the information that they download to their devices.

Specifically, the invention pertains to a notification method that controls the exchange of messages and data. The invention provides a delivery mechanism (e.g., one-byte delivery mechanism) that consolidates user status, updates, messages and/or other information. The one-byte notification minimizes network traffic by bundling device status information with the information that controls delivery of content and messages between the device and server 102. In contrast, conventional messaging systems require separate notifications for signaling changes in the device state and signaling changes in the data. In conventional messaging systems, traffic is measured in kilobytes as opposed to the one-byte notification method.

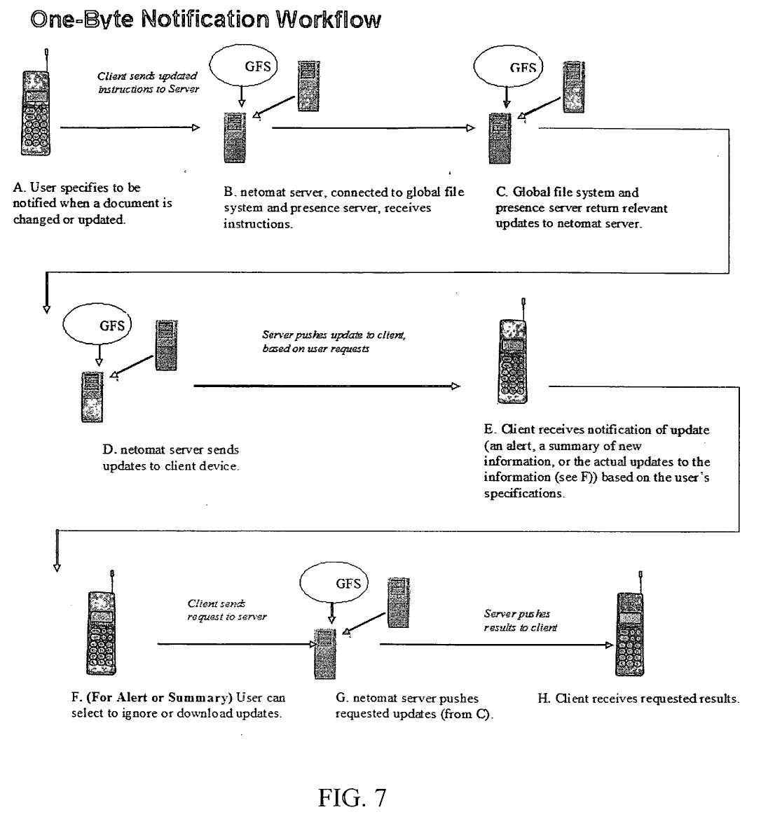

FIG. 7 shows a flow diagram of one-byte notification in accordance with an embodiment of the present invention. At stage A, user equipment sends instructions (e.g., end-user-defined instructions) to a server specifying that the user equipment is to be notified when, for example, a document is changed or updated (e.g., such as when updates to syndicated content are available or when a user has persisted a response to a document in which the user participates). The user equipment may also specify whether it will receive a one-byte notification of the update(s), a summary of the update(s), or the actual update(s) themselves when update(s) are available. At stage B, the server receives the instructions. At stage C, a global file system (and other equipment such as the presence interface) provides update(s) to the server, these update(s) including update(s) relevant to the user's preferences. At stage D, based on the the user's preferences, the server “pushes” to the user equipment either a one-byte notification (alert) of the update(s) to the user, a summary of the update(s), or the actual update(s) themselves, which the user receives at stage E. For an alert or summary, the end-user can select to ignore or download the update(s) at stage F. In response to a request to download the update(s), the server pushes the update(s) to the user equipment at stage G and the user equipment receives the content at stage H. In another embodiment, the user equipment may perform a “pull” notification procedure in which the user equipment, for example, queries the server every “n” seconds in order to request update(s) from the server (e.g., in addition to alerting the server as to the status of the user equipment).

The one-byte notification in accordance with the present invention may take various forms. For example, in one embodiment, the 8 bits (one-byte) notification may be used to store one ASCII character such as Y, N, S or P, where each character may represent a notification of (or request for) specific content (e.g., notifications regarding syndicated content updates only) or any/all update content (e.g., the “Y” character representing a notification that an update is available without specifying the type of update). In another embodiment, the 8 bits may be used to represent status codes that represent specific information, such as 0-99 representing status information for presence (e.g., available or busy), 100-199 representing status information for documents, and 200-255 representing error codes. In another embodiment, the 8 bits can be used to define types of changes (e.g., 4 bits) such as a change in a document's expiration date, as well as attributes associated with those changes (4 bits) such as an indication that the change is urgent or that confirmation of the change or some other action required.

Dynamic Concatenation of Server Interfaces

Requests to servers must be properly formatted so that servers can read the requests and format responses. Mobile devices 108 having client applications installed thereon can request information from various server interfaces 104 using a single call. In another embodiment, the server can provide clientless devices with an option to send such a concatenated call. With conventional methods, such as CGI (Common Gateway Interface) and HTTP, such requests are separated into multiple calls, one for each interface. In contrast, a client application in accordance with the present invention may generate a call that requests, for example, information from both the presence interface and also an interface for user searches. The single call can include a series of traditional HTTP calls, each with arguments modified in a way that causes the server to process the HTTP calls simultaneously. The invention uses a standard and protocol (HTTP) in a more efficient way. The server can aggregate all of the requested content into a single response that it sends to the requesting device.

HTTP provides several useful client/server calls, such as HTTPPOST, to post data to a server, and HTTPGET, to request a response. Complicated systems require efficient methods to send more complex requests. A web application usually consists of several HTTPPOST requests and HTTPGET requests, for example an HTTPPOST request can be used for submitting user data to the server, another HTTPPOST request can be user to register any user.

To send such requests, the client application automatically concatenates different requests and responses, rather than sending a separate request to each interface 104. An interface is the point at which a connection is made between the client and the server so that they can exchange information. Each interface is part of a hierarchy in which interfaces inherit the properties of higher-level interfaces. This inheritance extends the capabilities of server interfaces 104 by combining the functionality of multiple interfaces, as these interfaces can pass more information to a server during a single request; for example, to receive user status and new user data in a single request to server 102.

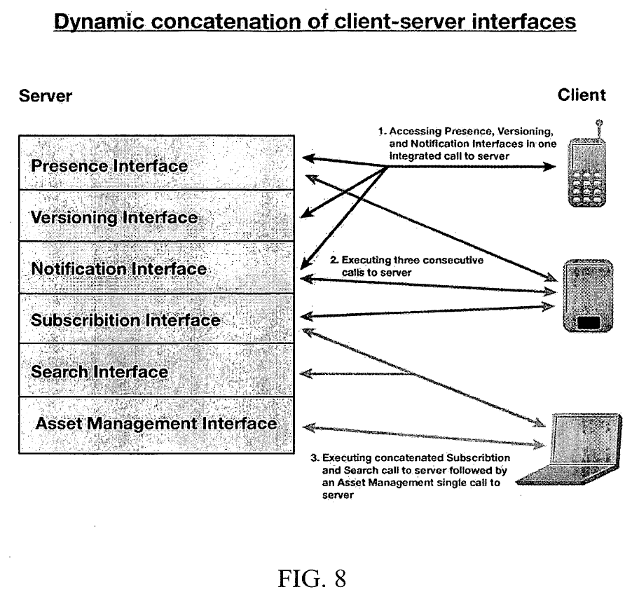

For example, FIG. 8 shows dynamic concatenation of server interfaces in accordance with an embodiment of the present invention. As shown, a first mobile device may access the presence, versioning and notification interfaces in a single, integrated call to server 102. A second mobile device may execute separate, consecutive calls to interfaces of server 102. A non-mobile device may execute a single integrated call to the subscription and search interfaces, and a separate call to the asset management interface.

As another example, presence in system 100 is tightly coupled with documents. A person can both have a global presence and be present within a particular document or collections of documents. A netomat document with presence becomes a live collaborative environment. As described in connection with FIG. 1, the presence interface (PI) is responsible for user's presence and availability. The notification interface (NI) is responsible for notifying users of updates to their spaces and spaces they participate in. User notification can use either a PULL or a PUSH mechanism. Contact lists are created and managed automatically through Invite, Subscription and Notification Interfaces. The PI interface may have the following structure:

```
<hdlr value=”prsnc”>
  <param name=”avlblty” value=”available”/>
  <param name=”status” value=”busy”/>
  <param name=”mood” value=”happy”/>
  <param name=”ticket” value=”
VNdzTYIYkqF1Qo56sucz4ale1d/RvCRufnIFQRNfdTA=”/>
  <param name=”docroot” value=”/maciej/NewYork/index.nml”/>
  <param name=”lng” value=”eng”/>
  <param name=”alias” value=”Superwoman”/>
  <param name=”contact” value=”http://mobile.netomat.net/maciej/
  profile”>
</hdlr>
```

The NI interface may have the following structure:

```
<hdlr value=”add”>
  <param name=”nmv” value=”path_to_history_file”/>
  <param name=”ticket” value=”
VNdzTYIYkqF1Qo56sucz4ale1d/RvCRufnIFQRNfdTA=”/>
  <param name=”user” value=”user_name”/>
  <param name=”time” value=”polling_or_push_time”/>
  <param name=”extends” value=”PresenceInterface”/>
  <param name=”implements” value=”Version”/>
</hdlr>
```

Below is a sample HTTP GET request and server response using the Common Gateway Interface with concatenated Presence and Notification Interfaces. The Notification Interface inherits from the Presence Interface and implements the DocumentListener interface.
GET /account/cgi-bin/gettime2.cgi?nmv=/maciej/NewYork/index.nmv&time=30&user=maciej&r=0.44471 429614350&extends=PresenceInterface&implements=DocumentListener2HTTP/1.1Accept:*/*
x-flash-version: 7,0,19,0
Accept-Encoding: gzip, deflate
User-Agent: Mozilla/4.0 (compatible; MSIE 6.0; Windows NT 5.1; SV1; NET CLR 1.1.4322)
Host: mobile.netomat.net
Connection: Keep-Alive
Cookie: JSESSIONID=94A4AD4182586179AD64097BF51637B1.mobile-0
HTTP/1.1 200 OK
Date: Wed, 03 Nov 2004 18:54:05 GMT
Server: Apache
Content-length: 50
Keep-Alive: timeout=15, max=94
Connection: Keep-Alive

Content-Type: text/plain; charset=ISO-8859-1

```
<nmv path=”/maciej/NewYork/index.nmv”>
<lm>1099507331</lm>
<user type=”br”>maciej
<param name=”avlblty” value=”available”/>
<param name=”status” value=”busy”/>
  <param name=”mood” value=”happy”/>
  <param name=”ticket” value=”
VNdzTYIYkqF1Qo56sucz4ale1d/RvCRufnIFQRNfdTA=”/>
  <param name=”docroot” value=”/maciej/NewYork/index.nml”/>
  <param name=”lng” value=”eng”/>
  <param name=”alias” value=”Superwoman”/>
  <param name=”contact” value=”http://mobile.netomat.net/maciej/
  profile”>
</user>
</nmv>
```

The server response returns both the last modified string as well as document-bound presence information. ‘br’ indicates that the user is using a browser.

Content Syndication Delivered via an Intermediary Server

Content syndication refers to a technology that allows a content consumer to subscribe to a content producer's feed. There are many formats for distributing syndicated content in the client/server environment, including RSS (Really Simple Syndication) and ICE (Information and Content Exchange). These formats distribute content to subscribers in a similar fashion, whereby content must be loaded from the content server for every user. Considering the vast number of content subscribers, this method of distribution puts tremendous load on communication networks, creates bottlenecks, and increases demand for storage.

In an embodiment, the invention provides a way to easily distribute syndicated content to millions of users in a way that minimizes network traffic, eliminates duplication of content, and provides a content sharing mechanism that is scalable.

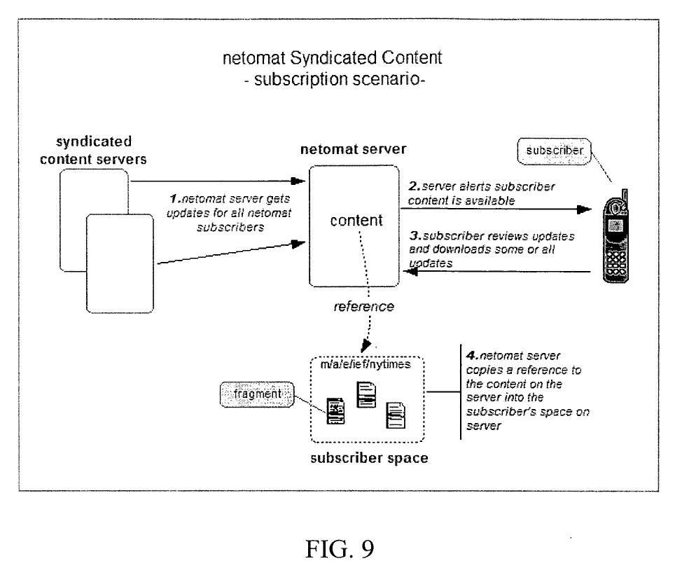

The invention implements the delivery of syndicated content in ways that are distinct from traditional approaches. First, all news feeds from a syndicated content server are aggregated to server 102 that acts as an intermediary for scheduling and delivering updates to devices 108. FIG. 9 illustrates the subscription scenario. By aggregating all feeds to server 102, subscribers are decoupled from the original feed, thereby eliminating the bottleneck that can occur with concurrent download requests. Server 102 controls the traffic and insulates devices 108 from excessive network traffic and bottlenecks.

Secondly, syndicated content remains on server 102 where it is shared by requesting devices, further reducing network traffic, potential bottlenecks, and storage demands. Server 102 periodically downloads content from one or more syndication servers, and alerts devices 108 with client applications and that subscribe to the syndicated content when the content is available. The client can selectively request updates, which the server optimizes for delivery to the client. If the client requests content, server 102 copies a reference (link) to the content into the client's netomat space (e.g., as a fragment to a document associated with the syndicated content), but leaves the actual content on the server.

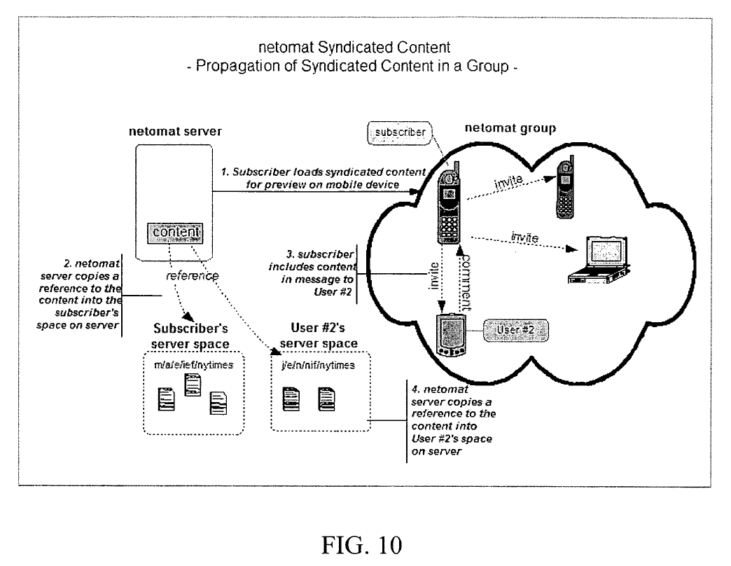

Additionally, one user can easily share syndicated content with other users. For example, when a user selects syndicated content, the content is inserted into a message flow and is shared with the other users. Thus, a news feed (for example) can be dynamically inserted into an ongoing conversation and instantly shared with others without an additional forwarding mechanism. The user can then invite any other user to share a syndicated content feed. FIG. 10 illustrates how content is shared. Invitees are notified of subsequent updates to a news feed, which may be ignored or downloaded.

Users can post comments within groups; thereby opening up a conversation and/or forming collaborative documents. When a member of a group receives a subscribed-to feed, all members of the group receive notification of the feed as well. Individual group members may choose to receive or ignore the feed, further reinforcing the social nature of a group. Groups can easily accommodate, for example, in the order of millions of people due to the low overhead associated with content distribution and the automated insertion of content into a message.

In another aspect of the present invention, various functionality is provided that enhances the capabilities of mobile users with respect to mobile messaging. This functionality may be provided at least in part by a client application running on the mobile devices. For example, such a client may be downloaded and installed on the mobile device from the internet or resident in memory on the mobile device at the time of purchasing by the end user. In another example, the messaging functionality may be provided in a clientless approach by resources (e.g., a browser and/or media player) other than a dedicated client application. In one embodiment, document-level presence information may be provided that indicates, for example, whether a document is available for review, whether the document has changed, who is accessing or working on the document and/or when the document was last updated. In another embodiment, functionality may be provided that allows the user to record, play back and edit messages and message threads. For example, the user may be presented with an option to search message content stored at a remote site based on the meta-information stored for that content. In another embodiment, “push to message” functionality may be provided for sending a message to a user that is currently offline, for scheduling delivery of a message for a specified date and time and/or geographic location, and/or for connecting with a user (and zero or more other users) when that user retrieves a message. These features are now described in greater detail.

Network-, Presence-, and Location-Aware Documents

Presence is typically understood as the online or offline status of users in a communication network. An example of conventional presence is instant messaging, such as AOL's Instant Messaging system and “Buddy List,” where the server knows if a user is online or offline and can also track more granular states of presence such as busy, away, typing, and idle. In this system, the focus is on the user.

In an embodiment, the present invention introduces a new type of presence called document level presence. As an alternative to or in addition to presence information about the user, the invention allows users of system 100 to locate and collaborate on documents. Document presence provides meaningful information to users regarding document state, location, and network awareness. Users with appropriate permissions can see if a document is available for review, if a document has changed, who is accessing or working on a given document, who is present in online conversations (message threads), and when the document was last updated.

As described above, an nml document may include meta-information such as author, location, and date and timestamp, which is known to server 102 and can be queried by users. Document presence is important in collaborative environments, e.g., signing documents and managing incremental changes made by different participants. Location awareness, as presented by global positioning system (GPS) data, provides information about where the document was created. Network awareness gives document objects the ability to adjust based on where they are being shipped and the state of the document presence; i.e., a document can deliver or append one or more of its fragments as dictated by the network state. For example, when a client application installed on a mobile device determines that the client is or is likely to dropp data packets (e.g., based on the network bandwidth), the client may request the server to send fewer fragments at a given time. For clientless applications, the server may send a default number of fragments (e.g., 1 fragment) at a given time.

If any part of the document is being worked on, the system is aware of the document's presence and location. That information can be queried on by users who have permission. For example, users can query who looked at and who altered content on a specific date. Documents are self managing objects in time and space; document-level presence adds another level of granularity as to what comprises a document and how it is processed.

Record and Playback Functionality of Messages and Message Threads

Traditional multimedia such as web sites, photographs, and streaming media files do not allow users to edit transmitted documents and only allow limited options for filtering or identifying desired information and for playback.

Playback, the animated sequence in which information in the document appears, is usually seen as a more important issue for time-based media, such as a video or speech that displays in frames-per-second, as opposed to non-time based media, such as messaging threads and bulletin boards. However, accessing and ordering information is important for both time-based and non time-based media.

In an embodiment, the present invention allows any message exchange or collaboration to be selectively recorded and selectively played back. The invention provides search and select functionality so that users can locate and select desired playback information. For example, a user may play back an entire document from beginning to end based on the meta information which, as described herein, defines an order in which fragments of the media were persisted by server 102 to memory 106. As another example, playback order can be altered, stopped, and started based on user edits that can occur at any point in the document.

Selective record/playback functionality is possible due to the underlying structure of a document, i.e., a collection of fragments. Recorded conversations consist of a collection of small-size fragments, each of which has been automatically tagged as meta information. Message exchanges can be selectively recorded by applying filters to the meta information embedded in the fragments as well as to predefined settings (e.g., playing back only fragments generated by a given author, on a specific date, in a specific location, and/or during a specific time.

Playback functionality is enabled by loading and displaying fragments in defined order. The order and content of the playback can be defined and redefined in real time by applying different filters and sorting algorithms to the message, thereby enabling playback to begin anywhere within a document.

Push-to-Message Functionality

Push-to-message functionality may be provided as follows:

Alert-and-message enables a netomat user to send an instant message to another netomat user when the user is offline. If the user is offline the netomat application on their mobile device will automatically launch, alerting the user of the message. Current mobile messaging systems can “wake up” applications on devices by using push registry mechanism. Similarly, the innovation can “wake up” the netomat application or load the message onto the system for later delivery. Waking up an application can be scheduled for any time; for example immediately, in two hours, or in two months. Alert-and-message meta information is embedded into the document itself, rather than being a network function, which makes this information searchable and less vulnerable to delivery problems.

Schedule-to-deliver enables a netomat user to specify the time and geographic location for a message delivery. For example, a netomat user can create a message to be delivered to another netomat user on a specific date, such as “Oct. 1, 2010,” and at a certain location, such as “Chicago, O'Hare Airport”. Users can also schedule a message to delete at a set time. Schedule-to-deliver meta information is embedded into the document itself, rather than being a network function, which makes this information searchable and less vulnerable to delivery problems.

Connect-on-delivery enables a user, and other selected users, to connect to the receiving user, when the message is successfully delivered. For example, a netomat user could send a message to congratulating another user on a birthday. When the birthday user accepts the message, several other users are simultaneously connected to congratulate the birthday user. Connect-on-delivery meta information is embedded into the document itself, rather than being a network function, which makes this information searchable and less vulnerable to delivery problems.

Thus it is seen that systems and methods are provided for multimedia messaging with mobile devices. Although particular embodiments have been disclosed herein in detail, this has been done by way of example for purposes of illustration only, and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventor reserves the right to pursue such inventions in later claims.

What is claimed is:

1. A method for messaging media between a sender and one or more recipients, said method comprising:
receiving a media message intended for communication to said one or more recipients;
storing said media message as a document remotely from user equipment of said sender and said one or more recipients;
communicating said media message to said one or more recipients; and
maintaining said document in said remote storage subsequent to said communicating.

2. The method of claim 1, further comprising designating said sender and said one or more recipients as participants in said document, thereby creating an association between said sender and said one or more recipients.

3. The method of claim 1, wherein said receiving said media message comprises receiving a media message comprising two or more media types selected from the group of media types consisting of text, image, audio, and video.

4. The method of claim 1, wherein said user equipment of at least one of said sender and said one or more recipients is a mobile device.

5. The method of claim 1, further comprising:
providing access to a document participant to said document; and
in response to a request from the document participant, modifying said accessed document or remotely storing a new document comprising multimedia content from said accessed document.

6. The method of claim 1, further comprising:
providing a capability whereby a first document participant can write to said document by submitting a response; and
providing a capability whereby a second document participant can write simultaneously to said document by submitting a response.

7. The method of claim 1, further comprising granting access rights to said document to a subset of users based on a predefined criteria.

8. The method of claim 1, wherein at least one of said received message and said communicated message comprises a short code that abbreviates the coded structure of a coded tree or sub-tree.

9. The method of claim 8, further comprising defining said short code.

10. The method of claim 1, further comprising:
receiving a request for said document from a document participant, wherein said document comprises a plurality of fragments; and
transmitting only a portion of said fragments to said document participant in response to said request.

11. The method of claim 1, wherein communicating said message to said one or more recipients comprises delivering said message as inline compressed ASCII encoded binary assets.

12. The method of claim 1, wherein communicating said message to said one or more recipients comprises:
maintaining an idle communication state with a recipient prior to receiving said message;
in response to receiving said message, transmitting a notification to said recipient indicating the availability of said message; and
communicating said message to said recipient in response to receiving a request for said message from said recipient.

13. The method of claim 1, further comprising receiving a request for an update to information associated with said document from a document participant, wherein said request is received simultaneously with one or more additional requests in the same call.

14. The method of claim 1, further comprising:
receiving syndicated content from a syndicated content server;
storing said syndicated content remotely from said document participants; and
providing said syndicated content to at least one of said document participants.

15. The method of claim 1, further comprising providing a document participant with document-level presence information selected from the group of document-level presence information consisting of information indicating whether the document has changed, and information identifying the document participant(s) currently accessing said document.

16. The method of claim 1, further comprising:
tagging said message with meta-information prior to storing said message (with said meta-information) as said document; and
allowing a document participant to search remotely stored documents based on said meta-information.

17. The method of claim 1, further comprising providing a document participant with push-to-message functionality selected from the group of functionality consisting of sending a message to another document participant that is currently offline, scheduling delivery of a message for a specified date, time and/or geographic location, and connecting to another document participant in a real-time environment when said another document participant retrieves a message.

18. A method for messaging media between a sender and a recipient, said method comprising:
receiving a media message intended for communication to said recipient, wherein user equipment of said recipient is a mobile device and wherein said media message comprises non-text media; and
communicating said media message to said one or more recipients, wherein said non-text media is communicated to said recipient as one or more inline ASCII encoded binary assets.

19. A server for facilitating the messaging of media between a sender and one or more recipients, said server configured to:
receive a media message intended for communication to said one or more recipients;
store said media message as a document remotely from user equipment of said sender and said one or more recipients;
communicate said media message to said one or more recipients; and
maintain said document in said remote storage subsequent to said communicating.

20. User equipment having a client application residing in local memory, said client application configured to:
provide a user with the ability to generate a media message intended for communication to one or more recipients;
transmit said media message to a server, wherein said media message is stored remotely from said user equipment and user equipment of said one or more recipients and maintained in said remote storage subsequent to said media message being communicated to said one or more recipients.

21. Computer readable media having computer-executable program code recorded thereon for performing the method comprising:
receiving a media message intended for communication to one or more recipients;
storing said media message as a document remotely from a sender of said media message and said one or more recipients;
communicating said media message to said one or more recipients; and
maintaining said document in said remote storage subsequent to said communicating.
